(19) United States
(12) Patent Application Publication
(10) Pub. No.: US 2025/0237982 A1
(43) Pub. Date: Jul. 24, 2025

(54) IMAGE FORMING APPARATUS AND METHOD OF CONTROLLING IMAGE FORMING APPARATUS

(71) Applicant: CANON KABUSHIKI KAISHA, Tokyo (JP)

(72) Inventor: AKIHITO YOKOTE, Chiba (JP)

(21) Appl. No.: 19/025,897

(22) Filed: Jan. 16, 2025

(30) Foreign Application Priority Data
Jan. 18, 2024 (JP) 2024-006059

(51) Int. Cl. G03G 15/00; G03G 15/04

(52) U.S. Cl. CPC G03G 15/5041; G03G 15/04072; G03G 2215/00042; G03G 2215/00054; G03G 2215/00063

(57) ABSTRACT

Disclosed is an image forming apparatus configured to form an image on a sheet including an image forming unit configured to expose a photosensitive member with laser light, while the photosensitive member is rotating, to form an electrostatic latent image to develop the electrostatic latent image formed on the photosensitive member, a sensor configured to detect a pattern image formed by the image forming unit, and a controller configured to suppress density unevenness in a rotation direction of the photosensitive member of an image to be formed by the image forming unit, based on detection results which are obtained by the sensor and correspond to different positions of the pattern image in the rotation direction.

### BACKGROUND OF THE INVENTION

### Field of the Invention

The present disclosure relates to an image forming apparatus, such as a copying machine, a multifunction peripheral, or a printer.

### Description of the Related Art

For example, an image forming apparatus employing an electrophotographic system performs image formation by scanning a photosensitive drum with laser light. The photosensitive drum is a drum-shaped photosensitive member including a photosensitive layer on its surface. The image forming apparatus uniformly charges the photosensitive layer of the photosensitive drum rotating about a drum shaft, and then irradiates (scans) the photosensitive layer with laser light, to thereby form an electrostatic latent image on the photosensitive layer of the photosensitive drum. The electrostatic latent image is developed by toner to become a toner image, and the toner image is transferred onto a sheet. For example, heat and pressure are applied to the sheet having the toner image transferred thereon so that the toner image melts to be fixed. An image is formed (printed) on the sheet as described above.

Such an image forming apparatus has a possibility of occurrence of charging unevenness at the time of charging the photosensitive drum, exposure unevenness at the time of laser light scanning, development unevenness at the time of development, and the like. Those kinds of unevenness may cause occurrence of image density unevenness in a predetermined direction of an image formed on the sheet. For example, the image density unevenness occurs in a main scanning direction and a sub-scanning direction. The main scanning direction is a direction in which the laser light scans the photosensitive drum, and corresponds to a drum shaft direction. The sub-scanning direction is a direction intersecting with the main scanning direction, and corresponds to a rotation direction of the photosensitive drum.

In order to correct the image density unevenness, there is used a sheet in which an image forming range is divided into a plurality of regions, and a measurement image including a pattern image for measuring the image density unevenness is formed in each region. The image density unevenness is corrected by adjusting a laser light amount so that an image density difference between the regions is eliminated, based on measurement results of the pattern images of the respective regions. For example, in Japanese Patent Application Laid-open No. 2000-98675 and Japanese Patent Application Laid-open No. 2022-71704, there is proposed a technology of correcting the image density unevenness in the sub-scanning direction.

In Japanese Patent Application Laid-open No. 2000-98675, the image density unevenness in the sub-scanning direction caused in a rotation period of a developing sleeve is corrected. The developing sleeve is a member that is rotated in association with the rotation of the photosensitive drum to cause toner to adhere to the electrostatic latent image. In Japanese Patent Application Laid-open No. 2022-71704, the image density unevenness in the sub-scanning direction is corrected based on measurement results of a period and an amplitude of the image density unevenness in the sub-scanning direction.

The correction of the image density unevenness in the sub-scanning direction requires accurate matching between a rotation phase of a rotary member such as the photosensitive drum or the developing sleeve causing the image density unevenness and a detection position of the image density unevenness in the sub-scanning direction.

Meanwhile, the image forming apparatus has a function called sub-scanning magnification changing in which a laser irradiation interval in the sub-scanning direction is changed in order to correct sheet margin misalignment of an image in a final product, which is caused by conveyance speed unevenness of the sheet or peripheral speed unevenness between the rotary members in the image forming apparatus. In a case where this function is used, the measurement image for detecting the image density unevenness in the sub-scanning direction may extend in the sub-scanning direction depending on a setting amount in the sub-scanning magnification changing. This extension causes misalignment between the rotation phase of the photosensitive drum and the measurement image. The above misalignment hinders accurate determination of a correction amount of the image density unevenness.

Such a problem caused by the sub-scanning magnification changing may occur not only in the correction of the image density unevenness in the sub-scanning direction but in common in general correction control of an image performed by forming a measurement image on an image bearing member such as the photosensitive drum. One example thereof is correction processing performed by forming a measurement image for determining an image forming condition for forming an electrostatic latent image on the image bearing member in order to correct the image density. In view of the above-mentioned problem, the present disclosure is to provide a technology that allows correction processing performed by forming a measurement image to be executed with high accuracy.

### SUMMARY OF THE INVENTION

An image forming apparatus configured to form an image on a sheet according to one embodiment of the present disclosure includes an image forming unit configured to expose a photosensitive member with laser light, while the photosensitive member is rotating, to form an electrostatic latent image to develop the electrostatic latent image formed on the photosensitive member, a sensor configured to detect a pattern image formed by the image forming unit, and a controller configured to suppress density unevenness in a rotation direction of the photosensitive member of an image to be formed by the image forming unit, based on detection results which are obtained by the sensor and correspond to different positions of the pattern image in the rotation direction, wherein, a first interval between positions on the photosensitive member where laser light for the pattern image is applied in the rotation direction of the photosensitive member is different from a second interval between positions on the photosensitive member where laser light for an image that is formed so as to correspond to a print job is applied in the rotation direction.

A method of controlling an image forming apparatus for forming an image on a sheet according to another embodiment of the present disclosure includes the image forming apparatus including an image forming unit configured to expose a photosensitive member with laser light, while the photosensitive member is rotating, to form an electrostatic latent image, and develop the electrostatic latent image formed on the photosensitive member, a sensor configured to detect a pattern image formed by the image forming unit, and a controller, the method comprising executing, by the controller, suppressing density unevenness in a rotation direction of the photosensitive member of an image to be formed by the image forming unit, based on detection results which are obtained by the sensor and correspond to different positions of the pattern image in the rotation direction, wherein, a first interval between positions on the photosensitive member where laser light for the pattern image is applied in the rotation direction of the photosensitive member is different from a second interval between positions on the photosensitive member where laser light for an image that is formed so as to correspond to a print job is applied in the rotation direction.

Further features of the present invention will become apparent from the following description of exemplary embodiments (with reference to the attached drawings).

### BRIEF DESCRIPTION OF THE DRAWINGS

FIG. 1 is a configuration view for illustrating an image forming apparatus.

FIG. 2 is a configuration explanatory view for illustrating an image forming unit.

FIG. 3 is a flow chart for illustrating processing of correcting image density unevenness in a sub-scanning direction.

FIG. 4 is an exemplary view for illustrating a measurement image.

FIG. 5 is an explanatory view for illustrating potential measurement in the sub-scanning direction of a pattern image.

FIG. 6 is an explanatory view for illustrating the measurement image.

FIG. 7 is an explanatory diagram for illustrating a signal processor.

FIG. 8 is a graph for showing a relationship between an image density of an image formed on a photosensitive drum and an output signal output from a reflected light amount sensor.

FIG. 9 is a set of explanatory graphs for showing a relationship between an input image signal and an output image density.

FIG. 10 is a flow chart for illustrating image formation processing.

### DESCRIPTION OF THE EMBODIMENTS

Embodiments of the present disclosure are described with reference to the drawings. In the embodiments, as an example, a laser beam printer employing an electrophotographic system is described as an image forming apparatus. However, the image forming apparatus is not limited to the laser beam printer, and may be a printer other than the laser beam printer, such as a light emitting diode (LED) printer, as long as the electrophotographic system is employed.

### First Embodiment

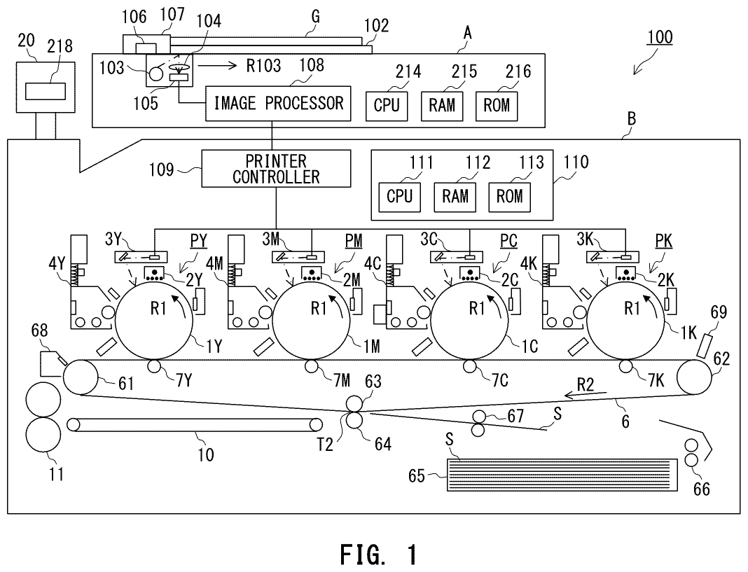

FIG. 1 is a configuration view for illustrating an image forming apparatus of a first embodiment of the present disclosure. An image forming apparatus 100 includes a reader A, a printer B, and an operation unit 20. The printer B prints an image on a sheet S. The reader A reads an image from a sheet (original G) having an image printed thereon. The operation unit 20 is a user interface. The operation unit 20 includes various key buttons or a touch panel as an input interface. The operation unit 20 includes a display unit 218 as an output interface. A user uses the operation unit 20 to give an instruction to start copying or perform various settings.

### <Reader>

The reader A includes a platen 102 for placing the original G thereon, a light source 103 for irradiating the original G placed on the platen 102 with light, an optical system 104, a light receiver 105, and an image processor 108. The reader A further includes a central processing unit (CPU) 214, a random access memory (RAM) 215, and a read only memory (ROM) 216. The light source 103, the optical system 104, and the light receiver 105 form an image reading unit for reading an image of the original G. A positioning member 107 and a reference white plate 106 are arranged at an edge portion of the platen 102. The positioning member 107 allows one side of the original G to be brought into abutment thereagainst to prevent oblique arrangement of the original G. The reference white plate 106 is to be used for shading correction of the image reading unit.

The optical system 104 causes reflected light, which is the light applied from the light source 103 and reflected on the original G, to be imaged on a reading face of the light receiver 105. The light receiver 105 includes a photoelectric conversion element such as a charge coupled device (CCD) sensor, and outputs an image signal obtained by converting the received reflected light into an electric signal. The light receiver 105 includes, for example, photoelectric conversion elements arranged in three rows so as to correspond to red (R), green (G), and blue (B). The light receiver 105 generates color component signals of respective colors including R, G, and B as image signals. The image reading unit reads lines of the image on the original G placed on the platen 102 one after another while moving in an arrow direction R103.

The image signals generated in the light receiver 105 are input to the image processor 108. The image processor 108 performs image processing such as A/D conversion, shading correction, and color conversion on the image signals acquired from the light receiver 105. The image processor 108 transmits the image signals having been subjected to the image processing to the printer B.

The CPU 214 executes a computer program stored in the ROM 216 to control the operation of the reader A. The RAM 215 is a work memory used in a case where the CPU 214 executes the processing. The reader A is controlled by the CPU 214 to perform various operations for reading the image of the original G.

### <Printer>

The printer B includes image forming units PY, PM, PC, and PK, an intermediate transfer belt 6, a secondary transfer roller 64, a fixing device 11, a sheet feeding cassette 65, and a printer controller 109. The printer B is a full-color printer of a tandem intermediate transfer type in which the image forming units PY, PM, PC, and PK are arranged along the intermediate transfer belt 6. The image forming unit PY forms a yellow image (toner image). The image forming unit PM forms a magenta image (toner image). The image forming unit PC forms a cyan image (toner image). The image forming unit PK forms a black image (toner image).

The intermediate transfer belt 6 is an image bearing member wrapped around and supported by a tension roller 61, a drive roller 62, and an opposing roller 63. A belt cleaner 68 is provided so as to be opposed to the tension roller 61. The intermediate transfer belt 6 is driven by the drive roller 62 to rotate in an arrow R2 direction at a predetermined process speed. The images (toner images) respectively formed by the image forming units PY, PM, PC, and PK are sequentially superimposed and transferred onto the intermediate transfer belt 6 at timings set in accordance with a rotation speed of the intermediate transfer belt 6. In this manner, a full-color image (toner image) is formed on the intermediate transfer belt 6.

The opposing roller 63 forms a secondary transfer portion T2 between the opposing roller 63 and the secondary transfer roller 64. The images of the respective colors having been transferred onto the intermediate transfer belt 6 are conveyed to the secondary transfer portion T2 and collectively transferred onto the sheet S. Through application of a DC voltage having a positive polarity to the secondary transfer roller 64, the images (toner images) of the respective colors charged to a negative polarity and borne on the intermediate transfer belt 6 are collectively transferred onto the sheet S. A developer that remains on the intermediate transfer belt 6 after the transfer is removed by the belt cleaner 68. The belt cleaner 68 rubs a cleaning blade against the intermediate transfer belt 6 to collect transfer residual toner remaining on the intermediate transfer belt 6 after passing through the secondary transfer portion T2.

Sheets S are stored in the sheet feeding cassette 65 and fed one after another. On a conveyance passage for conveying the sheets S, separation rollers 66 and registration rollers 67 are provided. The sheets S are fed from the sheet feeding cassette 65, separated into individual sheets by the separation rollers 66, and conveyed to the registration rollers 67. The registration rollers 67 receive the sheet S in a stopping state and allow the sheet S to stand by. The registration rollers 67 then convey the sheet S to the secondary transfer portion T2 in accordance with a timing at which the image borne on the intermediate transfer belt 6 is conveyed to the secondary transfer portion T2.

The sheet S having the image transferred thereto is conveyed by the secondary transfer roller 64 to the fixing device 11 via a conveyance belt 10. The fixing device 11 applies heat and pressure to the sheet S so that the image melts to be fixed to the sheet S. The sheet S having the image fixed thereto is discharged to an outside of a machine body of the printer B.

On a downstream side of the image forming unit PK in a rotation direction of the intermediate transfer belt 6, an image density sensor 69 serving as an image sensor is arranged at a position opposed to the drive roller 62 across the intermediate transfer belt 6. The image density sensor 69 is used for measuring an image density of an unfixed toner image having been transferred onto the intermediate transfer belt 6.

Image formation performed by the image forming units PY, PM, PC, and PK is described. The image forming units PY, PM, PC, and PK are different only in color of the developer (here, which is toner) to be used for development, and perform the same operation with the same configuration. In the following description, letters Y, M, C, and K are added to ends of the reference symbols in a case where the colors are distinguished, and the letters Y, M, C, and K at the ends of the reference symbols are omitted in a case where the colors are not distinguished.

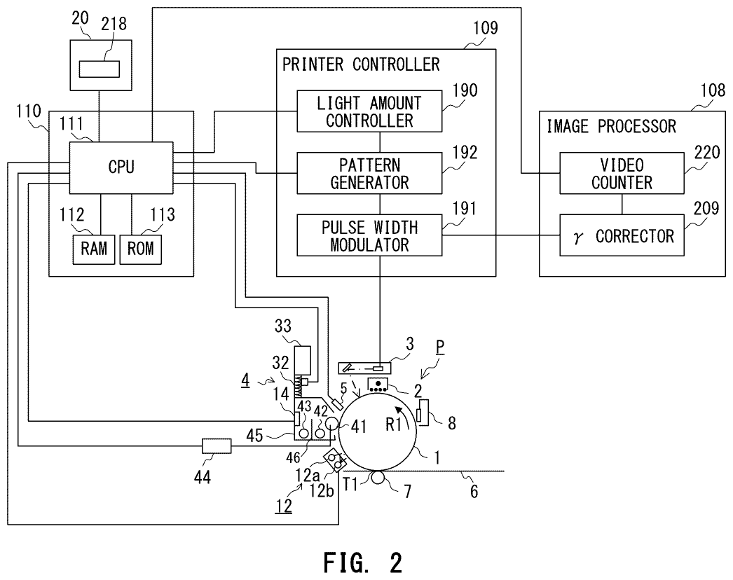

FIG. 2 is a configuration explanatory view for illustrating an image forming unit P. The image forming unit P includes a photosensitive drum 1, a charging device 2, an exposing device 3, a developing device 4, a reflected light amount sensor 12, a primary transfer roller 7, and a drum cleaner 8. The intermediate transfer belt 6 is sandwiched between the photosensitive drum 1 and the primary transfer roller 7. The charging device 2, the exposing device 3, the developing device 4, the reflected light amount sensor 12, the primary transfer roller 7, and the drum cleaner 8 are arranged around the photosensitive drum 1.

The photosensitive drum 1 in the first embodiment is an image bearing member having a configuration in which a photosensitive layer having a negative charging polarity is formed on an outer peripheral surface (surface) of an aluminum cylinder. The photosensitive drum 1 rotates in an arrow R1 direction about a drum shaft at a predetermined process speed. The photosensitive drum 1 is, for example, an OPC photosensitive member having a reflectance of about 40% with respect to far-red light (960 nm). The photosensitive drum 1 may be, for example, an amorphous-silicon-based photosensitive member having substantially the same reflectance.

The charging device 2 in the first embodiment is a scorotron charging device, which irradiates the photosensitive drum 1 with charged particles generated by corona discharge to charge the photosensitive layer on the surface of the photosensitive drum 1 to a uniform negative electric potential. The scorotron charging device includes a wire to which a high voltage is to be applied, a grounded shield portion, and a grid portion to which a desired voltage is to be applied. A predetermined charging bias voltage is applied to the wire of the charging device 2 from a charging bias power source (not shown). A predetermined grid bias voltage is applied to the grid portion of the charging device 2 from a grid bias power source (not shown). The photosensitive drum 1 is charged substantially to the voltage applied to the grid portion, though the voltage of the photosensitive drum 1 also depends on the voltage applied to the wire.

The exposing device 3 scans the surface of the charged photosensitive drum 1 in a drum shaft direction by reflecting laser light with a rotary mirror, to thereby form an electrostatic latent image on the surface of the photosensitive drum 1. Accordingly, the drum shaft direction of the photosensitive drum 1 corresponds to the main scanning direction. The sub-scanning direction intersecting with the main scanning direction corresponds to the rotation direction of the photosensitive drum 1. The sub-scanning direction is also a direction parallel to a conveying direction in which the sheet S is conveyed. In the vicinity of the photosensitive drum 1, a potential sensor 5 serving as a potential detector is provided. The potential sensor 5 can detect the potential of the electrostatic latent image formed on the photosensitive drum 1.

Through application of a development bias voltage to the developing device 4, the developing device 4 causes toner to adhere to the electrostatic latent image on the photosensitive drum 1, thereby forming an image (toner image) on the photosensitive drum 1. The developing device 4 includes, in a developer container 45 for storing the toner, a developing sleeve 41, a first conveyance screw 42, and a second conveyance screw 43. The developer container 45 in the first embodiment stores a two-component developer in which non-magnetic toner and magnetic carriers are mixed. The developer container 45 is divided into two chambers by a partition wall 46. The first conveyance screw 42 is provided in one chamber, and the second conveyance screw 43 is provided in the other chamber. The partition wall 46 has openings formed at two portions, and mutual inflow of the toner is allowed between the two chambers through the openings. The first conveyance screw 42 and the second conveyance screw 43 rotate to cause the developer to circulate in the developer container 45 while being stirred and mixed.

The developing sleeve 41 is arranged close to the photosensitive drum 1, and is rotated in association with the photosensitive drum 1. The developing sleeve 41 carries the developer in which the toner and the carriers are mixed. The developer carried by the developing sleeve 41 develops the electrostatic latent image on the photosensitive drum 1 through application of the development bias voltage to the developing sleeve 41. The development bias voltage is applied by a power supply unit 44. The power supply unit 44 is controlled by a controller 110 (CPU 111) to be described later to control the application of the development bias voltage.

The developing device 4 includes a toner amount sensor 14 for measuring the toner amount in the developer container 45. For example, a magnetic permeability sensor for detecting the magnetic permeability of the developer is used as the toner amount sensor 14. The developing device 4 is connected to a toner replenishment container 33 through a replenishment passage 32. In a case where a measurement result of the toner amount obtained by the toner amount sensor 14 is smaller than a predetermined amount, the toner is supplied from the toner replenishment container 33 to the developer container 45 via the replenishment passage 32.

The reflected light amount sensor 12 is an optical sensor including a light emitter 12a and a light receiver 12b, and is used for measuring the image density of the toner image formed on the photosensitive drum 1. The reflected light amount sensor 12 irradiates the toner image on the photosensitive drum 1 with light from the light emitter 12a. The light receiver 12b receives reflected light reflected by the toner image, and outputs an output signal corresponding to the received reflected light amount.

The primary transfer roller 7 presses an inner surface of the intermediate transfer belt 6 to form a primary transfer portion T1 between the photosensitive drum 1 and the intermediate transfer belt 6. Through application of a DC voltage having a positive polarity to the primary transfer roller 7, a toner image having a negative polarity borne on the photosensitive drum 1 is transferred onto the intermediate transfer belt 6 passing through the primary transfer portion T1. In the manner described above, the image forming unit P forms a toner image of a color corresponding to the photosensitive drum 1. The toner image is transferred from the photosensitive drum 1 onto the intermediate transfer belt 6. The drum cleaner 8 rubs a cleaning blade against the photosensitive drum 1 to collect the transfer residual toner remaining on the photosensitive drum 1 after the transfer onto the intermediate transfer belt 6.

The operation of such an image forming unit P is controlled by the printer controller 109 and the controller 110 provided in the printer B. The printer controller 109 controls the operation of the printer B. The controller 110 controls the operation of the entire image forming apparatus 100. The controller 110 is connected to the printer controller 109 and the image processor 108 of the reader A. Further, the operation unit 20 is connected to the controller 110. The operation unit 20 is also connected to the CPU 214 of the reader A. Although not shown, the controller 110 is also connected to the CPU 214 of the reader A.

The controller 110 includes the CPU 111, a RAM 112, and a ROM 113. The CPU 111 executes a computer program stored in the ROM 113 to control the operation of the image forming apparatus 100. The RAM 112 is a work memory used in a case where the CPU 111 executes the processing. Various operations of the reader A and the printer B of the image forming apparatus 100 are controlled by the CPU 111. The printer controller 109 includes a light amount controller 190, a pattern generator 192, and a pulse width modulator 191. The image processor 108 includes a video counter 220 and a y corrector 209.

The exposing device 3 in the first embodiment is a laser scanner including a rotary mirror. The exposing device 3 determines an exposure amount by the light amount controller 190 in order to obtain a predetermined image density level with respect to a laser output signal. In the first embodiment, in order to suppress the image density unevenness in the main scanning direction and the sub-scanning direction, light amount setting (LPW) is managed by allowing the light amount to be set in the unit of the width of about 30 mm in each direction. Further, the exposing device 3 outputs laser light in accordance with a laser drive pulse signal having a pulse width determined by the pulse width modulator 191 based on a drive signal generated through use of a tone correction table (LUT) of the y corrector 209.

The laser output signal is determined based on the tone correction table held by the y corrector 209. The tone correction table represents a relationship between the laser output signal and the image density level of the image to be formed, and the laser output signal is determined depending on the image density of the image to be formed.

The printer controller 109 acquires the image signal generated by the image processor 108. The printer controller 109 subjects the laser light output from the exposing device 3 based on the image signal to pulse width modulation (PWM) to form an image having an image density tone based on area coverage modulation. Accordingly, the printer controller 109 generates and outputs, by the pulse width modulator 191, a laser output signal having a width (time width) corresponding to the level of the image signal of each pixel. The laser output signal is a laser drive pulse signal. For an image signal specifying a high image density, the laser output signal becomes a pulse signal having a wide width. For an image signal specifying a low image density, the laser output signal becomes a pulse signal having a narrow width. For an image signal specifying an intermediate image density, the laser output signal becomes a pulse signal having an intermediate width.

The laser output signal (laser drive pulse signal) output from the pulse width modulator 191 is supplied to a light source (for example, a semiconductor laser) of the laser light of the exposing device 3. The semiconductor laser outputs the laser light for a time period corresponding to the pulse width of the laser output signal. Accordingly, the semiconductor laser is driven for a long time period for a pixel having a high image density, and is driven for a short time period for a pixel having a low image density. Thus, the dot size (area) of the electrostatic latent image formed on the photosensitive drum 1 varies depending on the image density of the pixel. The exposing device 3 performs exposure in a range longer in the main scanning direction for the pixel having a high image density, and performs exposure in a range shorter in the main scanning direction for the pixel having a low image density.

The pattern generator 192 generates an image signal of a measurement image formed to correct the image forming condition. In a case where the measurement image is formed, the pulse width modulator 191 generates a laser output signal based on the image signal of the measurement image acquired from the pattern generator 192. The measurement image in the first embodiment is, for example, an image for correcting the image density unevenness in the sub-scanning direction or an image for correcting the image density.

### <Magnification Setting in Sub-Scanning Magnification Changing>

As described above, the image forming apparatus 100 has a possibility of occurrence of sheet margin misalignment of an image formed on the sheet S due to conveyance speed unevenness of the sheet S or peripheral speed unevenness between rotary members such as the photosensitive drums 1. In order to correct the sheet margin misalignment, there is a function called sub-scanning magnification changing in which an irradiation interval of the laser light in the sub-scanning direction is changed.

A magnification setting value in the sub-scanning magnification changing is a fixed value adjusted for each image forming apparatus 100 by a service worker at the time of installing the image forming apparatus 100. In a case where an image corresponding to a print job is formed, an irradiation interval (second interval) of the laser light in the sub-scanning direction on the photosensitive drum 1 is adjusted in accordance with the magnification setting value in the sub-scanning magnification changing. The sub-scanning magnification changing can be performed not only by adjusting the irradiation interval of the laser light but also by correcting the image signal. With the interval (second interval) in the sub-scanning irradiation direction on the photosensitive drum 1 being adjusted, the length of the margin in the sheet S caused by the conveyance speed unevenness of the sheet S or the peripheral speed unevenness between the rotary members such as the photosensitive drums 1 is adjusted.

### <Shading Function>

In the first embodiment, the correction of the image density unevenness in the sub-scanning direction is performed through use of a shading function included in the exposing device 3. The light amount controller 190 acquires, from the ROM 113 of the controller 110, a correction value of a light amount corresponding to each exposure position and a phase in the sub-scanning direction, and controls the exposure by means of light amount setting (LPW) that is based on this correction value. The correction value of the light amount corresponding to each exposure position is obtained through image density unevenness correction to be described later. In the first embodiment, the ROM 113 stores correction values for the light amount setting at an interval of about 30 mm in each of the main scanning direction and the sub-scanning direction. The image density unevenness in the main scanning direction is handled by shading correction in the main scanning direction. In the shading correction in the main scanning direction, the light amount controller 190 acquires, from the ROM 113 of the controller 110, the correction value of the light amount corresponding to each exposure position in the main scanning direction, and controls the exposure by means of the light amount setting that is based on this correction value.

### <Image Density Unevenness Correction>

In the first embodiment, in order to suppress the image density unevenness caused in a predetermined direction (in this case, the sub-scanning direction), the controller 110 performs image density unevenness correction processing using the shading function. The controller 110 performs, for example, exposure amount correction processing for the exposing device 3 at the time of image formation, processing of forming a measurement image for image density unevenness detection, image density unevenness detection processing, and processing of calculating an image density correction amount.

A plurality of types of sensors can be used as a detection sensor for the image density unevenness detection processing. In the first embodiment, for example, the potential sensor 5 for detecting the potential unevenness of the photosensitive drum 1, which is one cause of the image density unevenness, or the image density sensor 69 for detecting the image density unevenness of the image borne on the intermediate transfer belt 6 can be used as the detection sensor for the image density unevenness detection processing. Here, a case in which the potential sensor 5 is used is described.

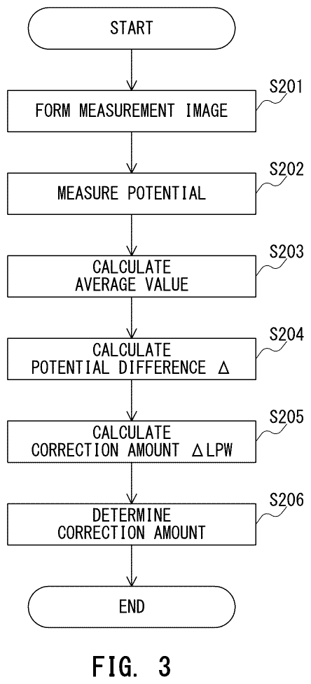

FIG. 3 is a flow chart for illustrating the processing of correcting the image density unevenness in the sub-scanning direction. The correction of the image density unevenness in the sub-scanning direction is performed for each color.

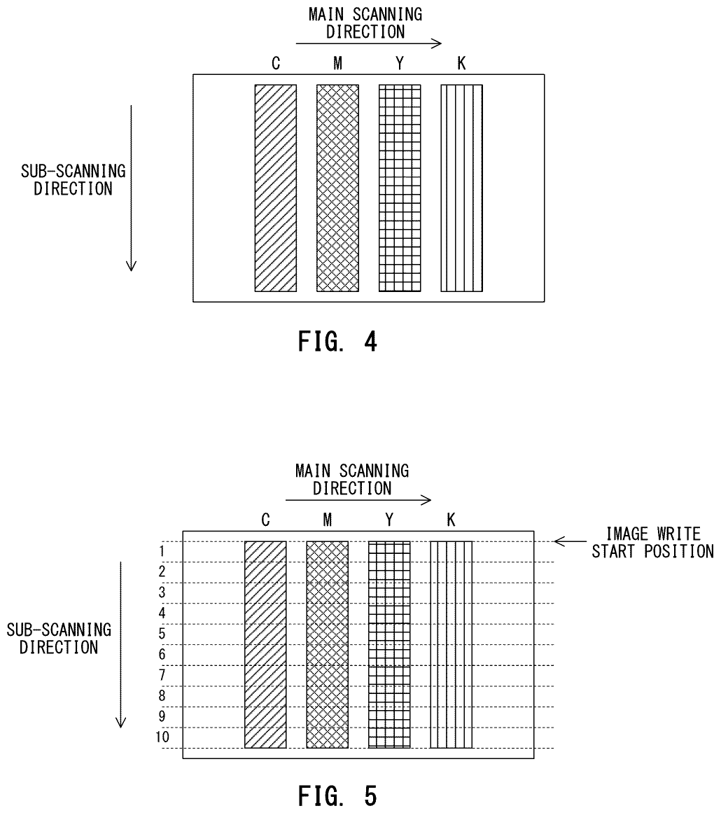

In a case where the controller 110 starts the processing of correcting the image density unevenness in the sub-scanning direction, the controller 110 starts formation of the measurement image for detecting the image density unevenness in the sub-scanning direction (Step S201). FIG. 4 is an exemplary view of the measurement image. The measurement image is a band image having a predetermined width in the main scanning direction and extending to have a predetermined length in the sub-scanning direction. The measurement image is formed based on an image signal indicating a uniform image density. This image signal is generated by the pattern generator 192. The band images (pattern images) of the respective colors are arranged at a predetermined interval in the main scanning direction. In the first embodiment, the pattern image of each color is formed based on an image signal indicating the image density of 40%. The example of FIG. 4 shows a state in which the pattern images of the respective colors are transferred onto the intermediate transfer belt 6. A monochromatic pattern image of a corresponding color is formed on each of the photosensitive drums 1 corresponding to the respective colors.

As for the image forming condition in the sub-scanning direction, it is required to associate the position of the measurement image for image density unevenness detection and the rotation phase of the rotary member that is the cause of the image density unevenness with each other. In the first embodiment, phase control of the image bearing member (in this case, the photosensitive drum 1) is performed so that a write start position of the pattern image and a home position of the rotation phase match each other. Moreover, as one feature of the first embodiment, the image formation is performed without performing correction using the setting value in the sub-scanning magnification changing in a case where the pattern image (measurement image) is formed. That is, the image signal of the measurement image generated by the pattern generator 192 is not subjected to processing using the setting value in the sub-scanning magnification changing. Accordingly, in a case where the measurement image is formed, an irradiation interval (first interval) of the laser light in the sub-scanning direction on the photosensitive drum 1 is not adjusted. Thus, the irradiation interval (second interval) of the laser light in the sub-scanning direction on the photosensitive drum 1 at the time of forming the image corresponding to the print job is different from the irradiation interval (first interval) of the laser light in the sub-scanning direction on the photosensitive drum 1 at the time of forming the measurement image.

In this manner, it is possible to obtain image density unevenness information representing image density unevenness accurately corresponding to the phase for one rotation of the image bearing member (in this case, the photosensitive drum 1) of each color. This is because it is required to associate the pattern image formed on the photosensitive drum 1 on the most upstream side in the image formation processing with the rotation phase of the photosensitive drum 1 with high accuracy. On the other hand, it is not required to apply the setting in the sub-scanning magnification changing which is set to correct, for example, the peripheral speed difference of the intermediate transfer belt 6 which occurs on the downstream side.

The controller 110 which has started the formation of the measurement image measures, by the potential sensor 5, the potential of the electrostatic latent image of the pattern image (Step S202). FIG. 5 is an explanatory view of potential measurement in the sub-scanning direction of the pattern image. The measurement in the sub-scanning direction is performed by equally dividing a predetermined length (in this case, about 300 mm) corresponding one rotation or more of the image bearing member (photosensitive drum 1) into ten regions to obtain sections 1 to 10 for about every 30 mm from the upstream side in the sub-scanning direction. In a case where the pattern image (measurement image) is measured, the potential sensor 5 measures the potential of the electrostatic latent image of the pattern image in the units of the sections.

The pattern image is formed to have a length in the sub-scanning direction (sub-scanning length) of 300 mm in order to detect the image density of about 300 mm which is the peripheral length of the photosensitive drum 1. In a case where the sub-scanning magnification changing is set to expand the image in the sub-scanning direction by 10%, the pattern image is extended by 10% in the sub-scanning direction so as to be formed to have 330 mm. Although measurement position of the potential sensor 5 can be shifted in accordance with the pattern image, in this case, the measurement position of the potential sensor 5 is deviated from the phase of the photosensitive drum 1 by about 30 mm at maximum. Accordingly, in a case where the sub-scanning magnification changing is performed, it becomes difficult to detect the image density with high accuracy, and it becomes difficult to correct the image density unevenness in the sub-scanning direction. Thus, in the first embodiment, no sub-scanning magnification changing is performed in a case where the measurement image is formed.

The controller 110 acquires the measurement result of the electrostatic latent image of the pattern image from the potential sensor 5, and calculates an average value of the potentials in the units of the sections (Step S203). The controller 110 calculates a potential difference Δ between the average value and each sectioned region (each of regions 1 to 10) (Step S204). The controller 110 calculates a correction amount (ALPW) corresponding to the calculated potential difference Δ (Step S205). With the above-mentioned processing, the controller 110 determines the correction amount (ALPW) of the light amount for correcting the image density unevenness in the sub-scanning direction for each of the regions 1 to 10 (Step S206).

As described above, the image forming apparatus 100 of the first embodiment can detect the image density unevenness in the sub-scanning direction with high accuracy based on the potential of the electrostatic latent image on the photosensitive drum 1. In this case, no sub-scanning magnification changing is applied to the measurement image. Accordingly, the image forming apparatus 100 can determine an optimum correction value of the image density unevenness in the sub-scanning direction, and can form a high-quality image with the image density unevenness in the sub-scanning direction being suppressed.

### Second Embodiment

In a second embodiment of the present disclosure, the image density unevenness is suppressed by detecting a change amount of the image density and correcting the tone correction table. The configuration of the image forming apparatus 100 is substantially the same as that of the first embodiment, and hence description thereof is omitted.

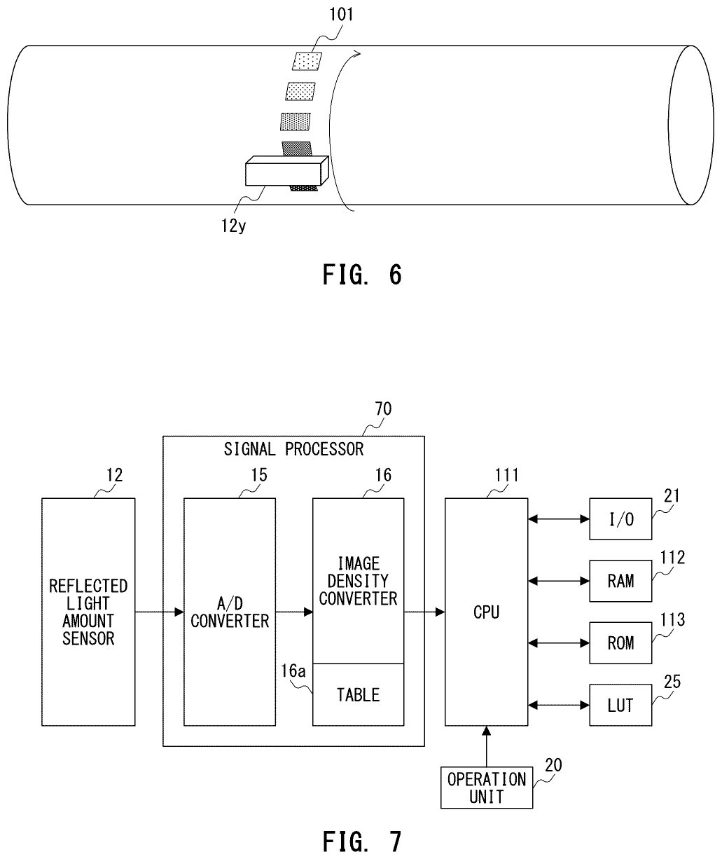

FIG. 6 is an explanatory view of a measurement image for measuring the image density. Description is given here of a yellow image, and hence FIG. 6 exemplifies a yellow measurement image 101 formed on the photosensitive drum 1Y on which a yellow image (toner image) is to be formed. In the second embodiment, the measurement image 101 is formed at a timing other than a timing during the image forming operation corresponding to the print job. The measurement image 101 is formed of a plurality of pattern images having different image densities, including a halftone pattern. The plurality of pattern images are formed side by side at a predetermined interval in the rotation direction of the photosensitive drum 1Y. The processing using the setting value in the sub-scanning magnification changing is not performed, and hence the predetermined interval at which the plurality of pattern images are arranged is the same as the first interval in the first embodiment.

The amount (image density) of toner adhering to the measurement image 101 is measured by detecting, by the reflected light amount sensor 12y, the amount of reflected light reflected by the measurement image 101. The reflected light amount sensor 12y is, as described above, an optical sensor including the light emitter 12a and the light receiver 12b. The light emitter 12a irradiates the photosensitive drum 1Y with light. The light receiver 12b detects only specular reflection light which is light applied from the light emitter 12a and reflected on the photosensitive drum 1Y. The reflected light amount sensor 12y measures the reflected light amount of the measurement image 101 as described above.

The reflected light amount sensor 12y is arranged at a position at which the image density can be measured, between the development position of the developing device 4Y and the primary transfer roller 7Y. The reflected light amount is measured at a timing at which the measurement image 101 formed in a region outside of the image formation region on the photosensitive drum 1Y passes through a measurement range of the reflected light amount sensor 12y. Tone correction (y correction) of yellow with which a predetermined constant image density (reflected light amount) is estimated to be obtained is executed based on the reflected light amount.

The same holds true also for the photosensitive drums 1M, 1C, and 1K corresponding to the other colors, and the reflected light amount sensors 12m, 12c, and 12k are arranged at positions at which the image density can be measured, between the development positions of the developing devices 4M, 4C, and 4K and the primary transfer rollers 7M, 7C, and 7K, respectively. The image densities of the images (toner images) formed on the photosensitive drums 1M, 1C, and 1K are detected by the reflected light amount sensors 12m, 12c, and 12k, respectively. Tone correction (y correction) of magenta, cyan, and black with which predetermined constant image densities (reflected light amounts) are estimated to be obtained is executed based on the detected image densities (reflected light amounts).

FIG. 7 is an explanatory diagram for illustrating the signal processor for processing the detection result (output signal) obtained by the reflected light amount sensor 12. The signal processor 70 is provided between the controller 110 and the reflected light amount sensor 12, or in the controller 110. The signal processor 70 includes an A/D converter 15 and an image density converter 16. The signal processor 70 is connected to the CPU 111.

The signal processor 70 acquires, from the reflected light amount sensor 12, an output signal which is an electric signal indicating the detection result of the image density. The output signal is an analog signal having a value corresponding to the amount of reflected light received by the reflected light amount sensor 12, and takes a voltage value of, for example, from 0 V to 5 V. The output signal is input to the A/D converter 15.

The A/D converter 15 converts the output signal acquired from the reflected light amount sensor 12 into, for example, an eight-bit digital signal. The eight-bit digital signal is transmitted to the image density converter 16. The image density converter 16 converts the digital signal acquired from the A/D converter 15 into an image density signal. The image density converter 16 includes a table 16a representing a relationship between a digital signal (output signal) corresponding to the reflected light amount and an image density signal (image density). The image density converter 16 converts the digital signal into the image density signal based on the table 16a.

The CPU 111 is connected to, in addition to the operation unit 20, the ROM 113, and the RAM 112, an I/O interface 21 and a look-up table (LUT) 25. The LUT 25 is a table that becomes a correction condition for setting, for the image signal indicating the image to be formed, a writing image halftone dot density of yellow, cyan, magenta, and black at the time of image formation in order to obtain an image having an appropriate image density.

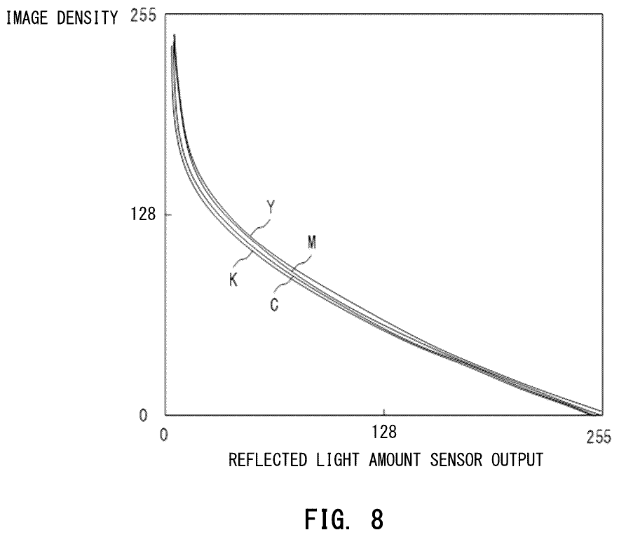

Tone control performed by such a configuration is described. FIG. 8 is a graph for showing a relationship between the image density of the image (toner image) formed on the photosensitive drum 1 and the output signal obtained by the reflected light amount sensor 12. This graph shows the relationship between the image density and the output signal in a case in which the image density of the measurement image 101 formed on the photosensitive drum 1 is gradually changed through area coverage modulation of each color. The voltage value of the output signal output from the reflected light amount sensor 12 under a state in which no toner adheres to the photosensitive drum 1 is set to 5 V (level 255 in the eight-bit digital signal). As the area coverage achieved by the toner becomes larger and the image density becomes higher, the voltage value of the output signal output from the reflected light amount sensor 12 becomes lower.

In the image density converter 16, the table 16a dedicated to each color having the characteristics of the graph shown in FIG. 8 is registered. The image density converter 16 uses the table 16a dedicated to each color to convert, for each color, the output signal output from the reflected light amount sensor 12 into the image density signal. In this manner, the image density of the measurement image 101 of each color is detected with high accuracy.

In the second embodiment, the CPU 111 forms the measurement image 101 at a timing other than the timing of image formation corresponding to the print job, detects the image density of the measurement image 101, and corrects table data of the LUT 25. The feature of the second embodiment resides in that the measurement image 101 is formed without applying the setting in the sub-scanning magnification changing described in the first embodiment.

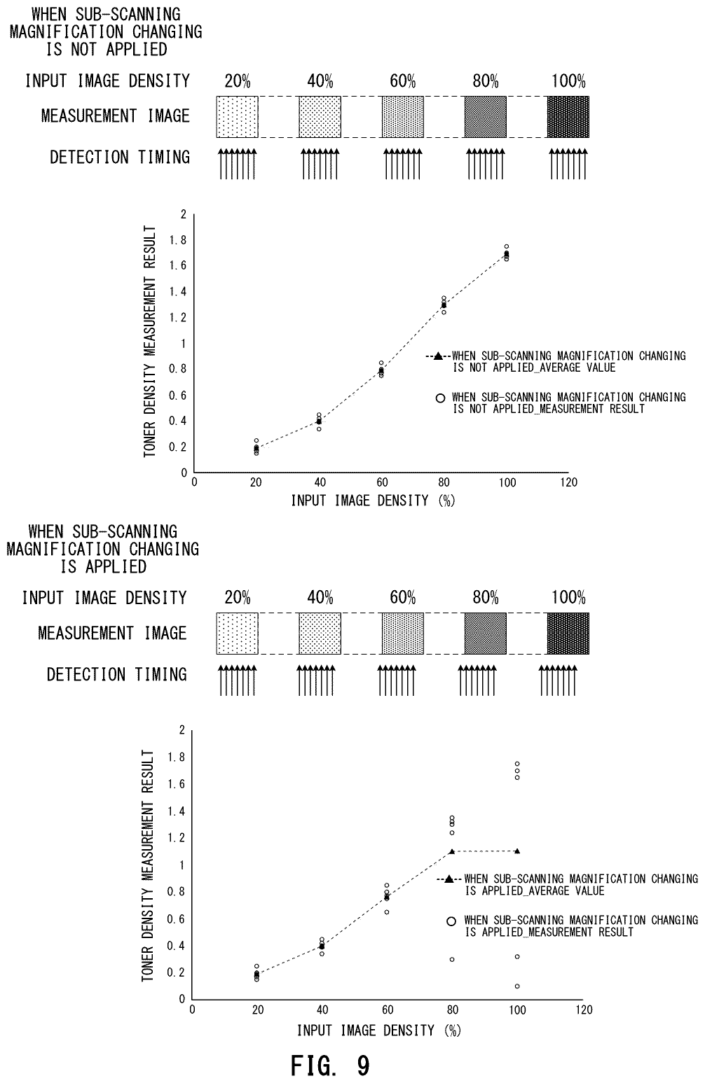

FIG. 9 is a set of explanatory graphs for showing the relationship between the input image signal and the image density (output image density) detected from the measurement image. Description is given of a difference in output image density between a case in which the setting in the sub-scanning magnification changing is applied and a case in which the setting in the sub-scanning magnification changing is not applied.

In a case where the measurement image 101 is formed while applying the setting in the sub-scanning magnification changing, the reading position of the reflected light amount sensor 12y is deviated in the sub-scanning direction from the formation position of the measurement image 101. On the photosensitive drum 1Y, the measurement image 101 in which five pattern images having different image densities are arranged side by side in the sub-scanning direction is formed. In a case where the size of the pattern image is 30 mm in the sub-scanning direction and an interval of the pattern images is 20 mm in the sub-scanning direction, the total length of the measurement image 101 in the sub-scanning direction is 230 mm. In a case where the measurement image 101 is formed under the setting in the sub-scanning magnification changing of 10%, the formation position of the measurement image 101 is deviated in the sub-scanning direction from the reading position of the reflected light amount sensor 12y by about 23 mm at maximum.

As shown in FIG. 9, the image density of each pattern image is measured based on detection results of detecting the image density a plurality of times by the reflected light amount sensor 12. For example, the image density of each pattern image is an average value of the detections results of detecting the image density a plurality of times. The deviation in the sub-scanning direction of the formation position of the measurement image 101 causes a change in the number of times of measurement for each pattern image, resulting in reduction of the accuracy of the detection result of the image density. Thus, detection failure is caused in the image density detected from the measurement image 101, and thus the table data correction of the LUT 25 cannot be accurately performed. Accordingly, in the second embodiment, the measurement image 101 is formed without applying the setting in the sub-scanning magnification changing so that the image density can be detected with high accuracy.

Also at the time of formation of the measurement image 101, similarly to the case of a normal image, the CPU 111 sets an appropriate image signal amount through use of the LUT 25 for the image signal of each color of cyan, magenta, yellow, or black. The table data of the LUT 25 used at the time of forming the measurement image 101 is substantially equal to the table data used at the time of the normal image formation at this time point. That is, the correction result obtained by the image density correction control performed until the last time is used as the table data of the LUT 25.

The image signal is corrected through use of the LUT 25 in order to reduce the deviation between the output image density detected from the measurement image 101 and the target value of the output image density. For example, in a case where the input image density of the measurement image 101 (image density instructed by the image signal) is level 128 and the target value is 128, the level of the image signal (image signal amount) is corrected through use of the LUT 25 so that the output image density becomes 128. However, the image characteristic of the image forming apparatus 100 is unstable and may always change. Accordingly, the table data of the LUT 25 is corrected based on a deviation amount ΔD between the input image density and the measurement result of the measurement image 101 (output image density). The deviation amount ΔD is a difference between the target value obtained from the measurement image 101 formed through use of the previous LUT 25 and the image density detected from the measurement image 101 formed through use of the new LUT 25.

In the second embodiment, an LUT correction table for correcting the deviation of the LUT 25 is stored in advance in the RAM 112. At the time of control, the CPU 111 calculates the correction amount corresponding to the deviation amount ΔD for all of the image density signals of the LUT correction table used until the last time, which have been stored in the RAM 112. The CPU 111 creates an LUT correction table of this time by correcting the previous LUT correction table by the amount of the deviation amount ΔD based on the calculated correction amount. Such rewriting (correction) of the LUT 25 is performed for each color at a timing at which the creation of the LUT correction table corresponding to the deviation amount ΔD is completed.

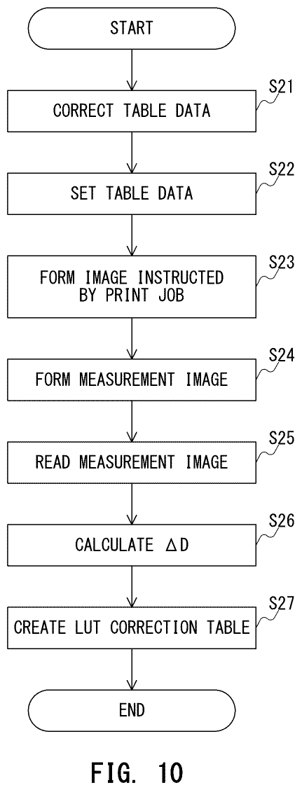

FIG. 10 is a flow chart for illustrating the image formation processing including the processing of creating the LUT correction table. The processing of creating the LUT correction table is executed along with the normal image formation processing corresponding to the print job during a period after the formation of the image corresponding to the print job is ended and until the next image is formed. FIG. 10 exemplifies the processing in a case in which the image is formed by one type of image processing.

In a case where the CPU 111 starts the processing corresponding to the print job, the CPU 111 corrects the table data of the LUT 25 based on the following expression (1) through use of the LUT correction table obtained by the previous processing (Step S21). The CPU 111 sets the corrected table data in the LUT 25 (Step S22). The CPU 111 performs image formation of an image instructed by the print job through use of this LUT 25 (Step S23). At the time of image formation of the image instructed by the print job, the irradiation interval (second interval) of the laser light in the sub-scanning direction on the photosensitive drum 1 is adjusted based on the magnification setting value in the sub-scanning magnification changing.

(Table data)=LUT+(LUT correction table used until last time). (1)

After the image is formed, the CPU 111 forms the measurement image 101 in a region outside of an image formation region (between the images) on the photosensitive drum 1 (Step S24). The region outside of the image formation region is a region between a trailing edge of the image and a leading edge of the next image. In a case where the measurement image is formed, the irradiation interval (first interval) of the laser light in the sub-scanning direction on the photosensitive drum 1 is not adjusted based on the magnification setting value in the sub-scanning magnification changing. The CPU 111 controls the reflected light amount sensor 12 to read the measurement image 101 (Step S25). The CPU 111 calculates the deviation amount ΔD between the image density of the measurement image 101 and the target value of the image density based on the reading result of the measurement image 101 (Step S26). The CPU 111 creates a new LUT correction table based on the calculated deviation amount ΔD and the LUT correction table used until the last time (Step S27).

As described above, the image forming apparatus 100 of the second embodiment can detect the measurement image 101 with high accuracy to execute optimum correction of the image density correction table (LUT). Accordingly, the image forming apparatus 100 of the second embodiment can always form a highly stable image with the change of the image density being suppressed. The image density at each position in the sub-scanning direction can be detected with high accuracy, and hence the image density deviation in the sub-scanning direction can be corrected with high accuracy.

The image density unevenness correction in the first embodiment suppresses the density unevenness based on the potential of the electrostatic latent image on the photosensitive drum 1 measured by the potential sensor 5. The image density unevenness correction in the second embodiment suppresses the density unevenness based on the density of the measurement image 101 on the photosensitive drum 1 measured by the reflected light amount sensor 12. However, the image density unevenness correction may employ a configuration in which the density unevenness in the sub-scanning direction is suppressed through use of a sensor other than those sensors. For example, the image forming apparatus 100 may include an inline sensor on the downstream side of the fixing device 11 in the direction in which the sheet S is conveyed, and may be configured to adjust the density unevenness in the sub-scanning direction based on a reading result of the measurement image (pattern image) on the sheet S read by the inline sensor.

As described in the first and second embodiments, in a case where the image forming apparatus 100 forms an image corresponding to the print job, the image forming apparatus 100 performs sub-scanning magnification changing to suppress variation in image size in the sub-scanning direction of an image formed on the sheet S. However, the sub-scanning magnification changing becomes a factor that hinders highly accurate detection of the image density at each position in the sub-scanning direction in a case where the image density in the sub-scanning direction of the image bearing member is detected so as to correspond to each position in the sub-scanning direction. This hinders suppression of the image density unevenness in the sub-scanning direction.

Accordingly, in a case where the image forming apparatus 100 forms the measurement image for detecting the image density in the sub-scanning direction, the image forming apparatus 100 forms the measurement image without changing the image size in the sub-scanning direction. In this manner, the rotation phase of the rotary member and the image density at each position in the sub-scanning direction of the measurement image are associated with each other, and the image density at each position in the sub-scanning direction can be detected with high accuracy. Accordingly, the image density unevenness in the sub-scanning direction can be suppressed with high accuracy. As a result, the image density unevenness can be suppressed, and an image having an appropriate image density can be stably obtained. That is, the correction processing performed by forming the measurement image can be executed with high accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-006059 filed Jan. 18, 2024, which is hereby incorporated by reference herein in its entirety.

What is claimed is:

1. An image forming apparatus configured to form an image on a sheet, comprising:
an image forming unit configured to expose a photosensitive member with laser light, while the photosensitive member is rotating, to form an electrostatic latent image to develop the electrostatic latent image formed on the photosensitive member;
a sensor configured to detect a pattern image formed by the image forming unit; and
a controller configured to suppress density unevenness in a rotation direction of the photosensitive member of an image to be formed by the image forming unit, based on detection results which are obtained by the sensor and correspond to different positions of the pattern image in the rotation direction,
wherein, a first interval between positions on the photosensitive member where laser light for the pattern image is applied in the rotation direction of the photosensitive member is different from a second interval, between positions on the photosensitive member where laser light for an image that is formed so as to correspond to a print job is applied in the rotation direction.

2. The image forming apparatus according to claim 1, wherein the second interval is determined based on a setting value for adjusting a length of a margin of the sheet, the margin being caused due to rotation unevenness of the photosensitive member.

3. The image forming apparatus according to claim 1, wherein the controller is configured to:
acquire a correspondence relationship between a rotation phase of the photosensitive member and the detection results which are obtained by the sensor and correspond to the different positions of the pattern image in the rotation direction; and
suppress the density unevenness based on the correspondence relationship.

4. The image forming apparatus according to claim 3, wherein the image forming unit is configured to rotate, before the pattern image is formed, the photosensitive member so that a write start position of the pattern image and a default rotation phase of the photosensitive member match each other.

5. The image forming apparatus according to claim 1, wherein the sensor comprises a potential sensor configured to measure a potential of an electrostatic latent image for measurement formed as the pattern image.

6. The image forming apparatus according to claim 1, wherein the sensor comprises an optical sensor including a light receiver configured to receive reflected light reflected from the pattern image.

7. The image forming apparatus according to claim 1, wherein the sensor comprises a sensor configured to read the pattern image formed on the sheet.

8. The image forming apparatus according to claim 7,
wherein the image forming unit further includes a fixing unit configured to fix the image formed on the sheet to the sheet, and
wherein the sensor is configured to read the pattern image on a downstream side of the fixing unit in a conveying direction of the sheet.

9. The image forming apparatus according to claim 1, wherein the pattern image comprises a band image having a longitudinal direction in the rotation direction.

10. The image forming apparatus according to claim 1, wherein the controller is configured to:
determine a light amount correction amount corresponding to each of a plurality of regions of the photosensitive member in the rotation direction based on the detection results of the sensor; and
control an exposure amount of the laser light based on the light amount correction amount corresponding to the each of the plurality of regions.

11. A method of controlling an image forming apparatus for forming an image on a sheet,
the image forming apparatus including:
an image forming unit configured to expose a photosensitive member with laser light, while the photosensitive member is rotating, to form an electrostatic latent image, and develop the electrostatic latent image formed on the photosensitive member;
a sensor configured to detect a pattern image formed by the image forming unit; and
a controller,
the method comprising executing, by the controller, suppressing density unevenness in a rotation direction of the photosensitive member of an image to be formed by the image forming unit, based on detection results which are obtained by the sensor and correspond to different positions of the pattern image in the rotation direction,
wherein, a first interval between positions on the photosensitive member where laser light for the pattern image is applied in the rotation direction of the photosensitive member is different from a second interval, between positions on the photosensitive member where laser light for an image that is formed so as to correspond to a print job is applied in the rotation direction.

12. The method of controlling an image forming apparatus according to claim 11, wherein the second interval is determined based on a setting value for adjusting a length of a margin of the sheet, the margin being caused due to rotation unevenness of the photosensitive member.

13. The method of controlling an image forming apparatus according to claim 11, further comprising:
acquiring, by the controller, a correspondence relationship between a rotation phase of the photosensitive member and the detection results which are obtained by the sensor and correspond to the different positions of the pattern image in the rotation direction; and
suppressing, by the controller, the density unevenness based on the correspondence relationship.

14. The method of controlling an image forming apparatus according to claim 13, further comprising rotating, by the controller, before the pattern image is formed, the photosensitive member so that a write start position of the pattern image and a default rotation phase of the photosensitive member match each other.

15. The method of controlling an image forming apparatus according to claim 11, further comprising measuring, by the sensor, a potential of an electrostatic latent image for measurement formed as the pattern image.

16. The method of controlling an image forming apparatus according to claim 11, wherein the sensor includes a light receiver configured to receive reflected light reflected from the pattern image.

17. The method of controlling an image forming apparatus according to claim 11, further comprising reading, by the sensor, the pattern image formed on the sheet.

18. The method of controlling an image forming apparatus according to claim 17,
wherein the image forming unit further includes a fixing unit configured to fix the image formed on the sheet to the sheet, and
wherein the method further comprises reading, by the sensor, the pattern image on a downstream side of the fixing unit in a conveying direction of the sheet.

19. The method of controlling an image forming apparatus according to claim 11, wherein the pattern image comprises a band image having a longitudinal direction in the rotation direction.

20. The method of controlling an image forming apparatus according to claim 11, further comprising:
determining, by the controller, a light amount correction amount corresponding to each of a plurality of regions of the photosensitive member in the rotation direction based on the detection results of the sensor; and
controlling, by the controller, an exposure amount of the laser light based on the light amount correction amount corresponding to the each of the plurality of regions.
